(19) United States
(12) Patent Application Publication
(10) Pub. No.: US 2009/0029657 A1
(43) Pub. Date: Jan. 29, 2009

(54) AUTO FREQUENCY CONTROL METHOD

(75) Inventors: Takuya Sakaishi, Tokyo (JP); Kazuaki Ishioka, Tokyo (JP); Yuji Inoue, Tokyo (JP); Shingo Higuchi, Tokyo (JP)

Correspondence Address: OBLON, SPIVAK, MCCLELLAND MAIER & NEUSTADT, P.C., 1940 DUKE STREET, ALEXANDRIA, VA, 22314, US

(73) Assignees: MITSUBISHI ELECTRIC CORPORATION, Chiyoda-ku (JP); NTT DoCoMo, Inc,, Chiyoda-ku (JP)

(21) Appl. No.: 11/996,504

(22) PCT Filed: Jul. 25, 2006
(86) PCT No.: PCT/JP2006/314676

§ 371 Date: Jan. 23, 2008

(30) Foreign Application Priority Data
Aug. 1, 2005 (JP) 2005-222976

(51) Int. Cl. H04B 1/04

(52) U.S. Cl. 455/113

(57) ABSTRACT

An auto frequency control method of this invention has a first step of a base station BS detecting a frequency deviation Δf_{BS} of an uplink signal transmitted from a mobile station MS, a second step of the base station BS transmitting an instructing amount of increase or decrease f_{cont} of the transmission frequency f_{MS} of the uplink signal to the mobile station MS on the basis of the frequency deviation Δf_{BS} of the uplink signal, and a third step of the mobile station MS shifting the transmission frequency f_{MS} of the uplink signal according to the instructing amount of increase or decrease f_{cont} transmitted from the base station BS.

### FIELD OF THE INVENTION

The present invention relates to an auto frequency control method for use in a cellular phone system and so on.

### BACKGROUND OF THE INVENTION

Auto frequency control (referred to as AFC: Auto Frequency Control from here on) for a mobile station MS in a conventional cellular phone system includes detection of a frequency deviation Δf_{MS} from, for example, the amount of phase rotation per unit time of a downlink signal, such as a pilot symbol having a known modulation pattern, which is transmitted from a base station BS, and control of TCXO (crystal oscillator) of the mobile station so as to cancel out this Δf_{MS}.

Hereafter, conventional AFC will be explained concretely. In a case in which a downlink signal transmitted at a frequency f_{BS} from a base station BS is observed, as a signal of frequency f_{MS}′=f_{BS}+Δf_{MS} which includes a frequency deviation Δf_{MS}, by a mobile station MS, the mobile station MS performs TCXO control on the signal so as to raise the reception frequency of the signal by Δf_{MS}. The mobile station thus absorbs the frequency shift due to a temperature change, between the base station's transmission frequency and the mobile station's reception frequency so as to have a good reception state (for example, refer to patent reference 1).

However, when the mobile station MS moves, Δf_{MS} detected by the mobile station MS includes a frequency shift due to a Doppler shift in addition to the variation in the frequency due to the temperature change. Therefore, the mobile station performs TCXO control on the signal to shift the reception frequency of the signal by Δf_{MS} so as to absorb Δf_{MS} including the influence of the Doppler shift.

At this time, in the cellular phone system, such as a CDMA system, in which transmission and reception are simultaneously carried out on the basis of a common oscillator, not only the reception frequency of the mobile station MS but the frequency of an uplink signal from the mobile station is shifted by Δf_{MS}, so that the uplink signal is transmitted at a frequency given by the following equation:

f_{MS}=f_{MS}′=f_{BS}+Δf_{MS}

Furthermore, because a Doppler shift Δf_{BS} is also added to the uplink signal which is transmitted from the mobile station MS with its frequency being shifted by Δf_{MS}, the resultant frequency of the uplink signal which the base station BS receives is given by the following equation:

f_{BS}′=f_{MS}+Δf_{BS}=f_{BS}+Δf_{MS}+Δf_{BS}

In this case, because Δf_{BS}≈Δf_{MS}, the influence of double the Doppler shift shown by the following equation is added to the frequency of the signal which the base station BS receives, and therefore the uplink communication quality degrades greatly.

Δf_{MS}+Δf_{BS}≈2Δf_{BS}

Because this degradation of the uplink communication quality further causes breakdown of loop control using uplink and downlink bidirectional communications, such as transmission power control, the uplink communication quality degradation also has a bad influence upon the operation of the whole system, including degradation in the downlink communication quality. Particularly, in communications at the time of high speed movements in a cellular phone system, such as a W-CDMA system, using a high frequency band, which has been in practical use in recent years, measures against this influence are indispensable remarkably.

[Patent reference 1] JP,2002-26769,A

Because the conventional auto frequency control method is implemented as mentioned above, a problem is that when a mobile station is moving at such a speed as one which makes the influence of Doppler shifts become large, some degradation occurs in the communication performance of the cellular phone system including those of base stations and mobile stations.

The present invention is made in order to solve the above-mentioned problems, and it is therefore an object of the present invention to implement an auto frequency control method which cannot be easily influenced by any Doppler shift by enabling a base station and/or a mobile station to transmit frequency deviation information and an instructing amount of increase or decrease in frequency, which are detected by each of them, between them.

### DISCLOSURE OF THE INVENTION

In accordance with the present invention, there is provided an auto frequency control method including: a first step of a base station detecting a frequency deviation of an uplink signal transmitted from a mobile station; a second step of the above-mentioned base station transmitting an instructing amount of increase or decrease in a transmission frequency of the above-mentioned uplink signal to the above-mentioned mobile station on a basis of the frequency deviation of the above-mentioned uplink signal; and a third step of the above-mentioned mobile station shifting the transmission frequency of the above-mentioned uplink signal according to the above-mentioned instructing amount of increase or decrease transmitted from the above-mentioned base station.

According to the present invention, because the above-mentioned mobile station performs automatic frequency control having a simple structure which follows only the amount of frequency increase and decrease of the above-mentioned uplink transmission from the above-mentioned base station, when uplink and downlink bidirectional communications are carried out, a large amount of degradation can be prevented from occurring in the reception quality of either of the bidirectional communications, and therefore the bidirectional communications can be kept in a good state.

### BRIEF DESCRIPTION OF THE FIGURES

FIG. 1 is a diagram showing an example of the operation of a cellular phone system using an auto frequency control method in accordance with Embodiment 1 of the present invention;

FIG. 2 is a flow chart showing a process carried out by a base station BS shown in FIG. 1;

FIG. 3 is a flow chart showing a process carried out by a mobile station MS shown in FIG. 1;

FIG. 4 is a diagram showing an example of the operation of a cellular phone system using an auto frequency control method in accordance with Embodiment 2 of the present invention;

FIG. 5 is a flow chart showing a process carried out by a base station BS shown in FIG. 4;

FIG. 6 is a flow chart showing a process carried out by a mobile station MS shown in FIG. 4;

FIG. 7 is a diagram showing an example of the operation of a cellular phone system using an auto frequency control method in accordance with Embodiment 3 of the present invention;

FIG. 8 is a flow chart showing a process carried out by a base station BS shown in FIG. 7; and

FIG. 9 is a flow chart showing a process carried out by a mobile station MS shown in FIG. 7.

### PREFERRED EMBODIMENTS OF THE INVENTION

Hereafter, in order to explain this invention in greater detail, the preferred embodiments of the present invention will be described with reference to the accompanying drawings.

### Embodiment 1

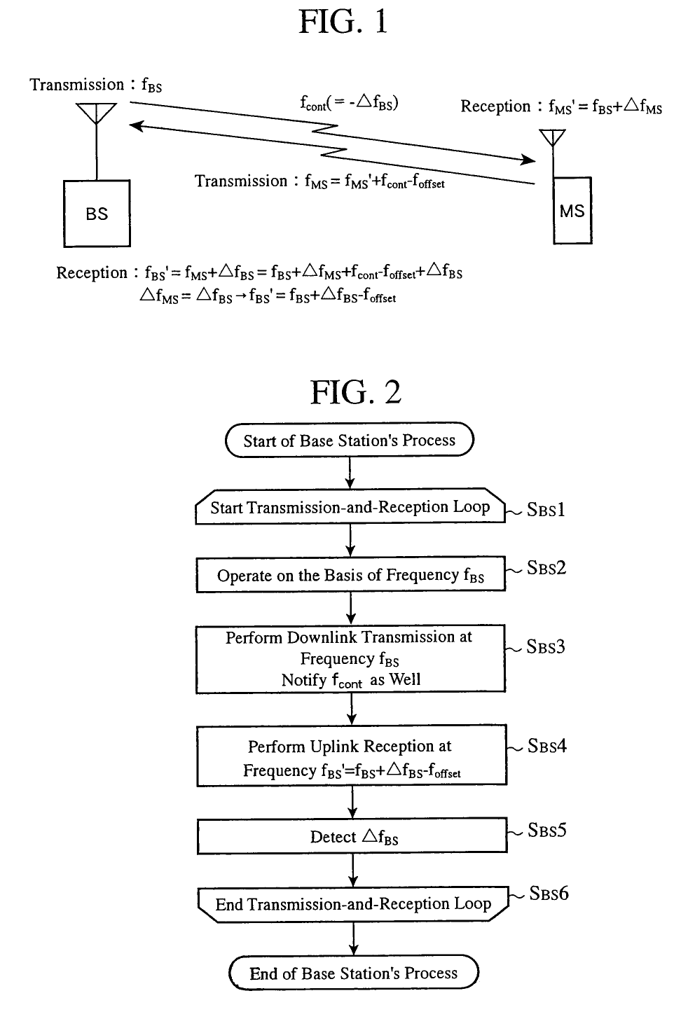

Hereafter, Embodiment 1 of the present invention will be explained. FIG. 1 is a diagram showing an example of the operation of a cellular phone system using an auto frequency control method in accordance with Embodiment 1 of the present invention. In FIG. 1, the downlink transmission frequency of a base station BS is expressed as f_{BS} and the uplink reception frequency of the base station is expressed as f_{BS}′, and the downlink reception frequency of a mobile station MS is expressed as f_{MS}′ and the uplink transmission frequency of the mobile station is expressed as f_{MS}.

Assume that the base station BS performs transmission and reception operations at a reference frequency which makes its downlink transmission frequency be f_{BS} and also makes its uplink transmission frequency be (f_{BS}′=f_{BS}−f_{offset}).

Assume that the mobile station MS sets TCXO to its reference frequency which makes its downlink reception frequency be f_{MS}′ and also makes its uplink transmission frequency be (f_{MS}=f_{MS}′−f_{offset}), and starts transmission and reception operations.

The explanation will be made by assuming that in this cellular phone system, uplink transmission is carried out using a frequency which is lower than the downlink transmission frequency f_{BS} by f_{offset}. f_{offset} shows the difference between the fundamental frequency of the base station BS and the fundamental frequency of the mobile station MS in the case of the fundamental frequency of the base station BS>the fundamental frequency of the mobile station MS.

Generally, from the viewpoints of the manufacturing cost etc., the base station BS can be equipped with relatively high precision TCXO as compared with the mobile station MS. Therefore, in accordance with the present invention, assume that the base station BS runs with a sufficient high degree of precision without actively changing its TCXO frequency while always keeping the reference frequency constant, and the mobile station MS performs the TCXO control according to the base station's frequency which is used as the reference and increases or decreases its operating frequency.

The base station BS can perform an AFC process of increasing or decreasing the reference frequency on the basis of the frequency deviation Δf_{BS} which is observed during transmission or reception, and so on.

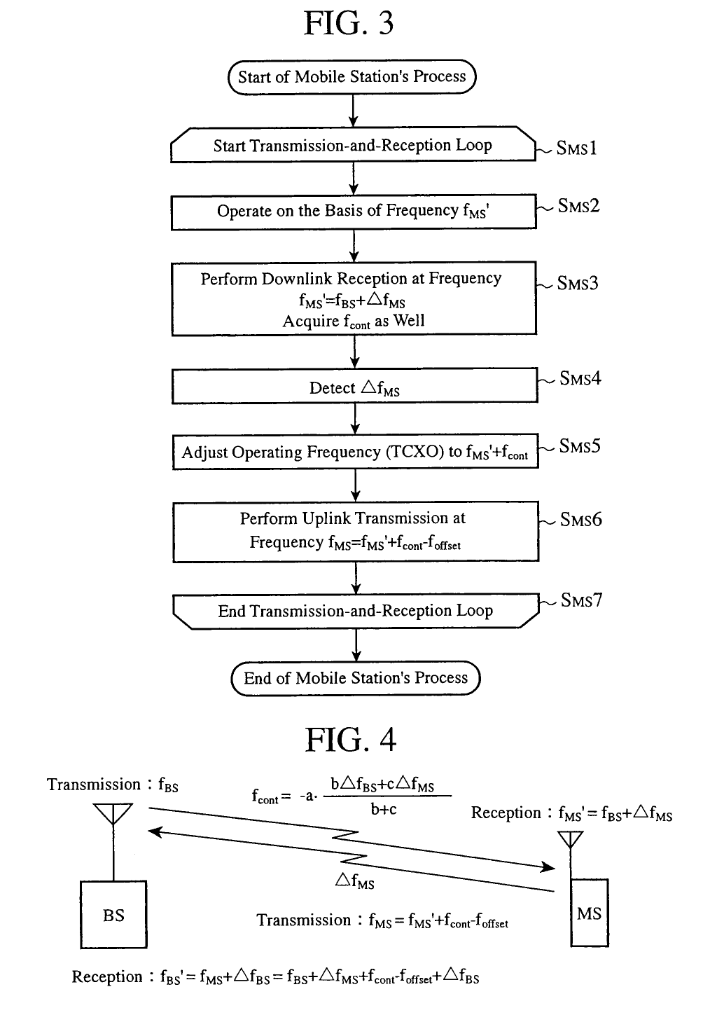

Next, the operation of the cellular phone system will be explained. FIG. 2 is a flow chart showing a process carried out by the base station BS shown in FIG. 1, and FIG. 3 is a flow chart showing a process carried out by the mobile station MS shown in FIG. 1. Hereafter, the processes of the base station BS and the mobile station MS will be explained with reference to FIGS. 1 to 3.

First, the base station BS starts a transmission-and-reception loop (step SBS1), and performs transmission and reception operations at the reference frequency which makes the downlink transmission frequency be f_{BS} and also makes the uplink reception frequency be (f_{BS}′=f_{BS}−f_{offset}) (step SBS2).

The mobile station MS starts the transmission-and-reception loop (step SMS1), and starts transmission and reception operations at the reference frequency which makes the downlink reception frequency be f_{MS}′ and also makes the uplink transmission frequency be (f_{MS}=f_{MS}′−f_{offset}) (step SMS2).

Next, when transmitting a downlink signal to the mobile station MS using the downlink transmission frequency f_{BS}, the base station BS transmits an instructing amount of frequency increase or decrease f_{cont} in the uplink transmission frequency f_{MS} together with the downlink signal (step SBS3). f_{cont} is a value which is based on a frequency deviation Δf_{BS} which can be detected from the uplink signal which the base station BS has received, as will be mentioned later, and is, for example, an amount of frequency which is obtained by multiplying Δf_{BS} by a minus sign so as to reverse this minus sign.

When the mobile station MS receives the downlink signal, which is transmitted at the downlink transmission frequency f_{BS} from the base station BS, at the reference frequency f_{MS}′ (=f_{BS}), a frequency deviation Δf_{MS} occurs in the downlink signal. The frequency deviation Δf_{MS} occurs due to the influence of the Doppler shift caused by the movement of the mobile station MS and a temperature change. Because AFC in accordance with this embodiment operates in such a manner that the downlink reception frequency f_{MS}′ of the mobile station MS converges to the downlink transmission frequency f_{BS} of the base station BS, in the mobile station MS the downlink reception frequency is observed as shown by the following equation:

f_{MS}′=f_{BS}+Δf_{MS}

The mobile station MS also acquires the instructing amount of frequency increase or decrease f_{cont} transmitted in step SBS3 (step SMS3).

The mobile station MS then detects the frequency deviation Δf_{MS} (step SMS4).

Next, on the basis of f_{cont} acquired in step SMS3, the mobile station MS performs TCXO control so that the reference frequency is increased by +f_{cont} (step SMS5). More specifically, the mobile station sets the reception frequency as shown by the following equation:

f_{MS}′=f_{BS}+f_{cont} (a new setting of f_{MS}′)

The mobile station also sets the transmission frequency as shown by the following equation:

f_{MS}=f_{MS}′−f_{offset}=f_{BS}+f_{cont}−f_{offset}

Next, the mobile station MS performs uplink transmission at the uplink transmission frequency (f_{MS}′+f_{cont}−f_{offset}) set in step SMS5 (step SMS6).

When the base station BS receives the uplink signal, which is transmitted from the mobile station MS at the uplink transmission frequency (f_{MS}′+f_{cont}−f_{offset}), at the reference frequency (f_{BS}′=f_{BS}−f_{offset}), a frequency deviation Δf_{BS} occurs in the uplink signal. Therefore, the uplink reception frequency is observed as shown by the following equation:

f_{MS}′+f_{cont}−f_{offset}+Δf_{BS}=(f_{BS}+Δf_{MS})+f_{cont}−f_{offset}+Δf_{BS}

Because the relative velocity of the mobile station MS, which is relative to the base station BS, is the same as the relative velocity of the base station BS, which is relative to the mobile station MS, in a case in which in the system, for example, f_{offset} is sufficiently small with respect to the carrier frequency in uplink and downlink communications, it can be assumed that the amount of Doppler shift included in Δf_{BS} is the same as that included in Δf_{MS}. Furthermore, if it can be assumed that the frequency deviation caused by noise and the temperature change converges to an average of 0 in the long term, and the influence of the frequency deviation can be removed with filtering, temperature compensation, etc., the following equation: (Δf_{BS}=Δf_{MS}) is established. In addition, when the following equation: (f_{cont}=−Δf_{BS}) is established, in the base station BS the uplink signal transmitted from the mobile station MS is observed with the uplink reception frequency being given by the following equation (step SBS4):

f_{BS}′=f_{BS}+Δf_{BS}−f_{offset}

The base station BS detects Δf_{BS} from the uplink reception frequency measured in step SBS4 (step SBS5).

Finally, the base station SB and the mobile station MS end their transmission-and-reception loops, and end their respective processes (steps SBS6 and SMS7).

In the system in which the base station BS transmits the instructing amount of frequency increase or decrease f_{cont} which cancels out the frequency deviation Δf_{BS} of the uplink signal which the base station BS has received to the mobile station MS, whereas the mobile station MS performs uplink transmission while sequentially adjusting the transmission and reception frequencies to frequencies which are obtained by adding f_{cont} to their original values, the reception signal of the mobile station MS is influenced by the frequency deviation Δf_{MS} and the reception signal of the base station BS is influenced by the frequency deviation Δf_{BS}, and their receiving characteristics degrade, though when it can be assumed that the following equation: Δf_{BS}=Δf_{MS} is established, the amount of degradation in the reception quality of the mobile station MS and the amount of degradation in the reception quality of the base station BS which are based on the Doppler shifts caused by the movement of the mobile station MS can be distributed so as to become equal to each other.

As mentioned above, in accordance with this Embodiment 1, because the mobile station MS is provided with AFC having a simple structure which complies with only the frequency increase or decrease instruction from the base station BS, when the mobile station and the base station carry out uplink and downlink bidirectional communications, a large amount of degradation can be prevented from occurring in the reception quality of either of the mobile station and the base station and therefore the bidirectional communications can be kept in a good state.

### Embodiment 2

Hereafter, Embodiment 2 of the present invention will be explained. FIG. 4 is a diagram showing an example of the operation of a cellular phone system using an auto frequency control method in accordance with Embodiment 2 of the present invention. Also in Embodiment 2, because the basic configuration of the auto frequency control method is the same as that of Embodiment 1 (FIG. 1), the explanation of the basic configuration will be omitted hereafter.

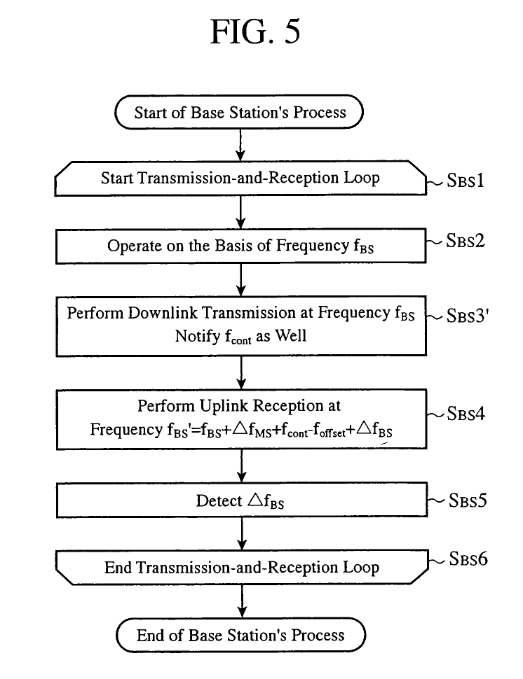

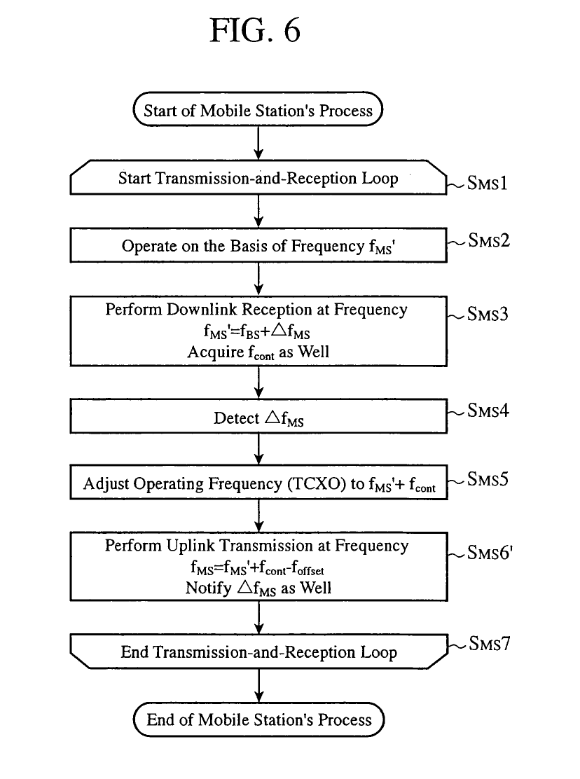

Next, the operation of the cellular phone system will be explained. FIG. 5 is a flow chart showing a process carried out by a base station BS shown in FIG. 4, and FIG. 6 is a flow chart showing a process carried out by a mobile station MS shown in FIG. 4. Hereafter, the processes carried out by the base station BS and the mobile station MS will b explained with reference to FIGS. 4 to 6.

First, the base station BS starts a transmission-and-reception loop (step SBS1), and performs transmission and reception operations at a reference frequency which makes its downlink transmission frequency be f_{BS} and also makes its uplink reception frequency be (f_{BS}′=f_{BS}−f_{offset}) (step SBS2).

The mobile station MS starts a transmission-and-reception loop (step SMS1), and starts transmission and reception operations at a reference frequency which makes its downlink reception frequency be f_{MS}′ and also makes its uplink transmission frequency be (f_{MS}=f_{MS}′−f_{offset}) (step SMS2).

Next, when transmitting a downlink signal to the mobile station MS using the downlink transmission frequency f_{BS}, the base station BS transmits an instructing amount of frequency increase or decrease f_{cont} in the uplink transmission frequency f_{MS} together with the downlink signal. f_{cont} has a value which is obtained by performing a weighted-sum operation on both a frequency deviation Δf_{BS} which can be detected from an uplink signal, as will be mentioned below, which the base station BS has received, and a frequency deviation Δf_{MS} which is observed from the downlink signal which the mobile station MS has received using coefficients a, b, and c. For example, f_{cont} has a value given by Equation 1 (step SBS3′).

$${f}_{cont} = - a \cdot \frac{b Δ {f}_{BS} + c Δ {f}_{MS}}{b + c} \qquad [ Equation 1 ]$$

Because when the relative value of b with respect to c is increased in Equation 1, it can be considered that greater importance is placed on Δf_{BS} observed by the base station BS, whereas when the relative value of c with respect to b is increased, it can be considered that greater importance is placed on Δf_{MS} observed by the mobile station MS, the weighting with the coefficients can be adaptively changed by taking into consideration the bit error rate of each of the uplink and downlink communications, and so on so that greater importance is placed on one of the measured values with a higher degree of reliability. Although the coefficient a is a parameter which determines the controlled variable and responsibility of AFC, because AFC diverges when the controlled variable is increased, it is desirable to set the coefficient a to a right small value which can make the mobile station and the base station operate with stability.

When the mobile station MS receives the downlink signal, which is transmitted at the downlink transmission frequency f_{BS} from the base station BS, at the reference frequency f_{MS}′ (=f_{BS}), a frequency deviation Δf_{MS} occurs in the downlink signal. The frequency deviation Δf_{MS} occurs due to the influence of the Doppler shift caused by the movement of the mobile station MS and a temperature change. Because AFC in accordance with this embodiment operates in such a manner that the downlink reception frequency f_{MS}′ of the mobile station MS converges to the downlink transmission frequency f_{BS} of the base station BS, in the mobile station MS the downlink reception frequency is observed as shown by the following equation:

f_{MS}′=f_{BS}+Δf_{MS}

The mobile station MS also acquires the instructing amount of frequency increase or decrease f_{cont} transmitted in step SBS3 (step SMS3).

The mobile station MS then detects the frequency deviation Δf_{MS} (step SMS4).

Next, on the basis of f_{cont} acquired in step SMS3, the mobile station MS performs TCXO control so that the reference frequency is increased by +f_{cont} (step SMS5).

More specifically, the mobile station sets the reception frequency as shown by the following equation:

f_{MS}′=f_{BS}+f_{cont} (a new setting of f_{MS}′)

The mobile station also sets the transmission frequency as shown by the following equation:

f_{MS}=f_{MS}′−f_{offset}=f_{BS}+f_{cont}−f_{offset}

When the mobile station MS performs uplink transmission at the uplink transmission frequency (f_{MS}′+f_{cont}−f_{offset}) set in step SMS5, the mobile station transmits the frequency deviation Δf_{MS} detected to the base station BS as well (step SMS6′).

When the base station BS receives the uplink signal, which is transmitted from the mobile station MS at the uplink transmission frequency (f_{MS}′+f_{cont}−f_{offset}), at the reference frequency (f_{BS}′=f_{BS}−f_{offset}), a frequency deviation Δf_{BS} occurs in the uplink signal. Therefore, the uplink reception frequency is observed as shown by the following equation (step SBS4):

f_{MS}′+f_{cont}−f_{offset}+Δf_{BS}=(f_{BS}+Δf_{MS})+f_{cont}−f_{offset}+Δf_{BS}

As in the case of Embodiment 1, because the relative velocity of the mobile station MS, which is relative to the base station BS, is the same as the relative velocity of the base station BS, which is relative to the mobile station MS, in a case in which in the system, for example, f_{offset} is sufficiently small with respect to the carrier frequency in uplink and downlink communications, it can be assumed that the amount of Doppler shift included in Δf_{BS} is the same as that included in Δf_{MS}. Furthermore, if it can be assumed that the frequency deviation caused by noise and the temperature change converges to an average of 0 in the long term, and the influence of the frequency deviation can be removed with filtering, temperature compensation, etc., the following equation: (Δf_{BS}=Δf_{MS}) is established. In addition, when the coefficient a=1 in Equation 1, the following equation: (f_{cont}=−Δf_{BS}=−Δf_{MS}) is established. Therefore, in the base station BS the uplink signal transmitted from the mobile station MS is observed with the uplink reception frequency being given by the following equation:

f_{BS}′=f_{BS}+Δf_{BS}−f_{offset}

The base station BS detects Δf_{BS} from the uplink reception frequency measured in step SBS4 (step SBS5).

Finally, the base station SB and the mobile station MS end their transmission-and-reception loops, and end their respective processes (steps SBS6 and SMS7).

In the system in which the base station BS transmits the instructing amount of frequency increase or decrease f_{cont} which cancels out the frequency deviation Δf_{BS} of the uplink signal which the base station BS has received to the mobile station MS, whereas the mobile station MS performs uplink transmission while sequentially adjusting the transmission and reception frequencies to frequencies which are obtained by adding f_{cont} to their original values, the reception signal of the mobile station MS is influenced by the frequency deviation Δf_{MS} and the reception signal of the base station BS is influenced by the frequency deviation Δf_{BS}, and their receiving characteristics degrade, though when it can be assumed that the following equation: Δf_{BS}=Δf_{MS} is established, the amount of degradation in the reception quality of the mobile station MS and the amount of degradation in the reception quality of the base station BS which are based on the Doppler shifts caused by the movement of mobile station MS can be distributed so as to become equal to each other.

As mentioned above, in accordance with this Embodiment 2, because the mobile station MS is provided with AFC having a simple structure which complies with only the frequency increase or decrease instruction from the base station BS, when the mobile station and the base station carry out uplink and downlink bidirectional communications, a large amount of degradation can be prevented from occurring in the reception quality of either of the mobile station and the base station and therefore the bidirectional communications can be kept in a good state.

Particularly, because Δf_{BS} and Δf_{MS} are measured on the basis of reception signals influenced by fading and so on in uplink and downlink communications, respectively, variations occur in the instantaneous measured values of the frequency deviations, though by performing a weighted-sum operation on Δf_{BS} and Δf_{MS} to determine the instructing amount of frequency increase or decrease f_{cont}, AFC can be performed on the basis of the frequency deviation measured values which are more stable.

### Embodiment 3

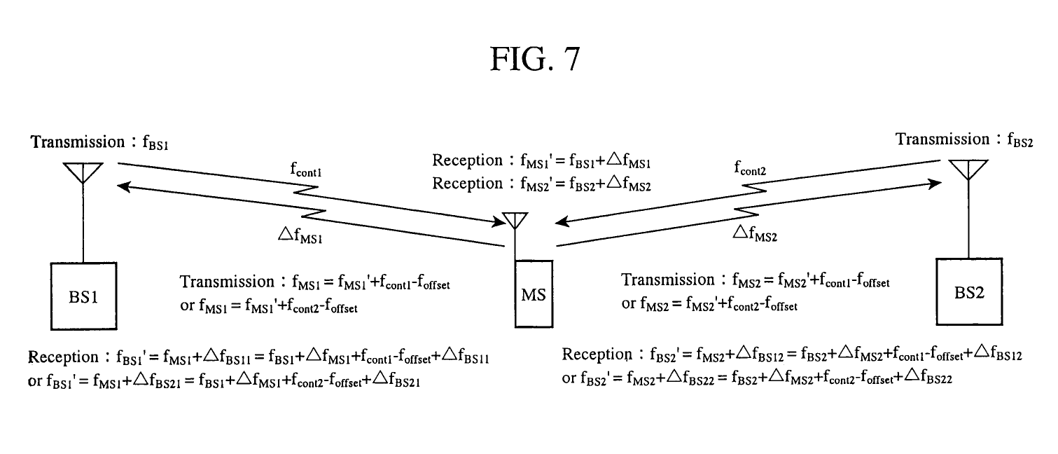

Hereafter, Embodiment 3 of the present invention will be explained. FIG. 7 is a diagram showing an example of the operation of a cellular phone system using an auto frequency control method in accordance with Embodiment 3 of the present invention. In Embodiment 3, an example of an operation of a mobile station MS communicating with a plurality of base stations BS1, BS2, . . . , and BSi (i is an arbitrary integer) simultaneously when, for example, carrying out a software handover will be shown.

Although in Embodiment 3 the example is shown assuming that the mobile station MS communicates with two base stations BS1 and BS2 simultaneously, in the auto frequency control method in accordance with the present invention, the number of base stations with which the mobile station MS communicates simultaneously is not limited to two.

Furthermore, although this explanation will be made assuming that the mobile station MS communicates with each of the plurality of base stations BSi using a different frequency and different transmission power, the mobile station MS can alternatively carry out communications with the plurality of base stations using an identical frequency or identical transmission power.

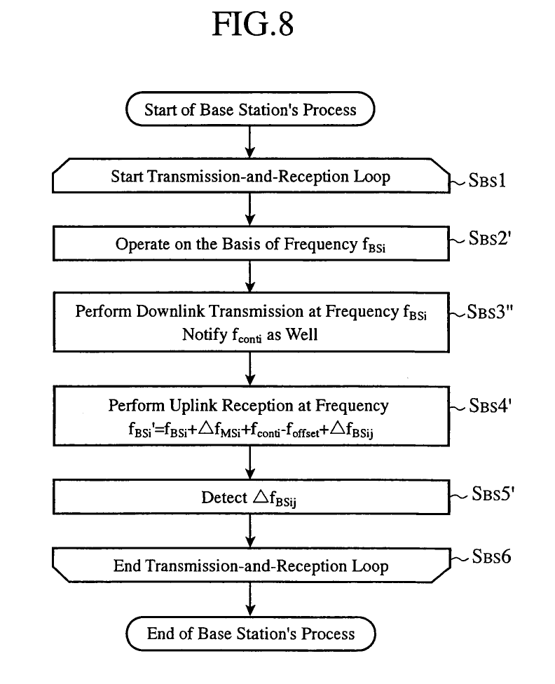

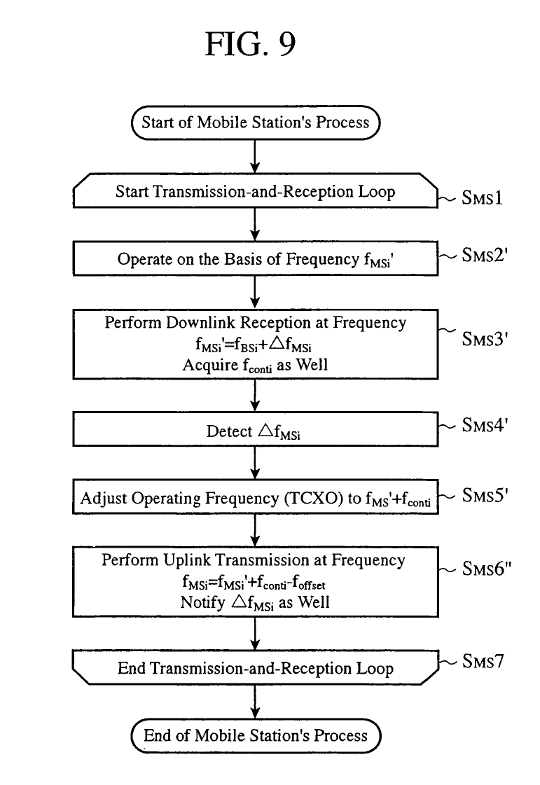

Next, the operation of the cellular phone system will be explained. FIG. 8 is a flow chart showing a process carried out by a base station BS shown in FIG. 7, and FIG. 9 is a flow chart showing a process carried out by a mobile station MS shown in FIG. 7. Hereafter, the processes carried out by the base station BS and the mobile station MS will be explained in time sequence with reference to FIGS. 1 to 3.

First, the base station BSi starts a transmission-and-reception loop (step SBS1), and performs transmission and reception operations at a reference frequency which makes its downlink transmission frequency be f_{BSi} and also makes its uplink reception frequency be (f_{BSi}−f_{offset}) (step SBS2′).

The mobile station MS starts a transmission-and-reception loop (step SMS1), and starts transmission and reception operations at a reference frequency which makes its downlink reception frequency be f_{MSi}′ and also makes its uplink transmission frequency be (f_{MSi}=f_{MSi}′−f_{offset}) (step SMS2′).

Next, when the base station BS1 transmits a downlink signal to the mobile station MS using a downlink transmission frequency f_{BS1}, the base station transmits an instructing amount of frequency increase or decrease f_{cont1} in the uplink transmission frequency f_{MS1} together with the downlink signal. Furthermore, when the base station BS2 transmits a downlink signal to the mobile station MS using a downlink transmission frequency f_{BS2}, the base station transmits an instructing amount of frequency increase or decrease f_{cont2} in the uplink transmission frequency f_{MS2} together with the downlink signal (step SBS3″).

When the mobile station MS receives the downlink signal, which is transmitted at the downlink transmission frequency f_{BS1} from the base station BS1, at the reference frequency (f_{MS1}′=f_{BS1}), a frequency deviation Δf_{MS1} occurs in the downlink signal. The frequency deviation Δf_{MS1} occurs due to the influence of the Doppler shift caused by the movement of the mobile station MS and a temperature change. Because AFC in accordance with this embodiment operates in such a manner that the downlink reception frequency f_{MS}′ of the mobile station MS converges to the downlink transmission frequency f_{BS} of each base station BS, in the mobile station MS the downlink reception frequency is observed as shown by the following equation:

f_{MS1}′=f_{BS1}+Δf_{MS1}

Similarly, when the mobile station MS receives the downlink signal, which is transmitted at the downlink transmission frequency f_{BS2} from the base station BS2, at the reference frequency (f_{MS2}′=f_{BS2}), a frequency deviation Δf_{MS2} occurs in the downlink signal. In the mobile station MS, the downlink reception frequency is observed as shown by the following equation:

f_{MS2}′=f_{BS2}+Δf_{MS2}

The mobile station MS also acquires the instructing amounts of frequency increase or decrease f_{cont1} and f_{cont2} transmitted in step SBS3″ (step SMS3′).

The mobile station MS then detects the frequency deviations Δf_{MS1} and Δf_{MS2} (step SMS4′).

The instructing amount of frequency increase or decrease f_{cont1} which the base station BS1 transmits to the mobile station MS can have a value shown by, for example, Equation 2 or Equation 3.

$$\begin{matrix}{f}_{cont 1} = - a \cdot \frac{b Δ {f}_{BS 11} + c Δ {f}_{MS 1}}{b + c} & [ Equation 2 ] \\ {f}_{cont 1} = - a \cdot \frac{b Δ {f}_{BS 21} + c Δ {f}_{MS 1}}{b + c} & [ Equation 3 ]\end{matrix}$$

Similarly, the instructing amount of frequency increase or decrease f_{cont2} which the base station BS2 transmits to the mobile station MS can have a value shown by, for example, Equation 4 or Equation 5.

$$\begin{matrix}{f}_{cont 2} = - a \cdot \frac{b Δ {f}_{BS 12} + c Δ {f}_{MS 2}}{b + c} & [ Equation 4 ] \\ {f}_{cont 2} = - a \cdot \frac{b Δ {f}_{BS 22} + c Δ {f}_{MS 2}}{b + c} & [ Equation 5 ]\end{matrix}$$

In Equations 2 to 5, Δf_{BSij} shows a frequency deviation which occurs, due to noise, a temperature change, a Doppler shift, and so on, in an uplink signal which the mobile station MS has transmitted at a frequency f_{MSi} when received by the base station BSj (j is an arbitrary integer) (refer to below-mentioned step SBS4′), and can be detected by the base station BSj (refer to below-mentioned step SBS5′) from the amount of phase rotation per unit time of a known pilot symbol which is transmitted by the mobile station MS in the uplink direction.

Furthermore, in Equations 2 to 5, a weighted-sum operation is performed on both the frequency deviation Δf_{BSij} which is observed from the uplink signal which the base station BSj has received, and the frequency deviation Δf_{MSi} which is observed from the downlink signal which the mobile station MS has received using coefficients a, b, and c.

While the mobile station MS receives the different instructing amounts of frequency increase or decrease f_{cont1} and f_{cont2} from the two base stations BS1 and BS2, respectively, the mobile station increases or decreases its transmission and reception frequencies according to one f_{conti} of the instructing amounts of frequency increase or decrease, depending upon the importance of communications with each base station (step SMS5′).

As an index used for judgment of the importance of communications with each base station, for example, one of the following indexes is used.

A combination of two or more of these indexes (1) to (10) can be used to judge the importance of communications with each base station.

(1) The signal-to-power ratio of the downlink signal in the mobile station for each base station;

(2) The receive error rate of the downlink signal in the mobile station for each base station;

(3) The distance between the mobile station and each base station;

(4) Whether the uplink transmission power of the mobile station for each base station is large or small;

(5) The relative velocity between the mobile station and each base station;

(6) Whether the Doppler shift amount of the downlink signal in the mobile station for each base station is large or small;

(7) Whether the communication duration between the mobile station and each base station is large or small;

(8) Whether the frequency deviation of the downlink signal in the mobile station for each base station is large or small;

(9) Whether the reception quality of the downlink signal or the trackability of the reception power for a downlink transmission power control command which the mobile station transmits to each base station is good or not; and

(10) Whether the trackability of a phase angle between a downlink common CH (channel) and a dedicated CH, which is transmitted from each base station in response to an FBI command for specifying the phase angle between the downlink common CH and the dedicated CH to a base station (refer to Chapter 5 of 3GPP TS 25.211 V5.3.0 and Chapter 7 of 3GPP TS 25.214 V5.3.0), which is transmitted from the mobile station, is good or not.

Hereafter, examples in which the indexes (1) to (10) are used, respectively, as the index used for judgment of the importance of communications with each base station will be explained.

First, an example in which the index (1) is used will be explained. According to the instructing amount of frequency increase or decrease f_{conti} from the base station BSi having a certain signal-to-power ratio or more which results in judgment that the reception quality is sufficient to be reliable, the mobile station MS increases or decreases its transmission and reception frequencies. When two or more base stations having the above-mentioned certain signal-to-power ratio or more exist, the instructing amount of frequency increase or decrease f_{conti} from a base station BSi with the highest signal-to-power ratio can be used by assuming that the instructing amount of frequency increase or decrease f_{conti} has a high degree of reliability. As an alternative, in order to improve the quality of communications with a base station BSi having a relatively-low signal-to-power ratio compared with those of the other base stations, the instructing amount of frequency increase or decrease f_{conti} from the base station BSi can be used. How to select the instructing amount of frequency increase or decrease f_{conti} which is used for the frequency increase or decrease is arbitrarily determined according to the intended use.

Next, an example in which the index (2) is used will be explained. According to the instructing amount of frequency increase or decrease f_{conti} from a base station BSi having a certain receive error rate or more which results in judgment that the reception quality is sufficient to be reliable, the mobile station MS increases or decreases its transmission and reception frequencies. When two or more base stations having the above-mentioned certain receive error rate or more exist, the instructing amount of frequency increase or decrease f_{conti} from a base station BSi with the lowest receive error rate can be used by assuming that the instructing amount of frequency increase or decrease f_{conti} has a high degree of reliability. As an alternative, in order to improve the quality of communications with a base station BSi having a relatively-high receive error rate compared with those of the other base stations, the instructing amount of frequency increase or decrease f_{conti} from the base station BSi can be used. How to select the instructing amount of frequency increase or decrease f_{conti} which is used for the frequency increase or decrease is arbitrarily determined according to the intended use.

Next, an example in which the index (3) is used will be explained. According to the instructing amount of frequency increase or decrease f_{conti} from a base station BSi having a certain communication range or less which results in judgment that the reception quality is sufficient to be reliable, the mobile station MS increases or decreases its transmission and reception frequencies. When two or more base stations having the above-mentioned certain communication range or less exist, the instructing amount of frequency increase or decrease f_{conti} from a base station BSi with the shortest communication range can be used by assuming that the instructing amount of frequency increase or decrease f_{conti} has a high degree of reliability. As an alternative, in order to improve the quality of communications with a base station BSi having a relatively-long communication range compared with those of the other base stations, the instructing amount of frequency increase or decrease f_{conti} from the base station BSi can be used. How to select the instructing amount of frequency increase or decrease f_{conti} which is used for the frequency increase or decrease is arbitrarily determined according to the intended use.

Next, an example in which the index (4) is used will be explained. According to the instructing amount of frequency increase or decrease f_{conti} from a base station BSi having certain uplink transmission power or less which results in judgment that the reception quality is sufficient to be reliable, the mobile station MS increases or decreases its transmission and reception frequencies. When two or more base stations having the above-mentioned certain uplink transmission power or less exist, the instructing amount of frequency increase or decrease f_{conti} from a base station BSi with the lowest uplink transmission power can be used by assuming that the instructing amount of frequency increase or decrease f_{conti} has a high degree of reliability. As an alternative, in order to improve the quality of communications with a base station BSi having relatively-high uplink transmission power compared with those of the other base stations, the instructing amount of frequency increase or decrease f_{conti} from the base station BSi can be used. How to select the instructing amount of frequency increase or decrease f_{conti} which is used for the frequency increase or decrease is arbitrarily determined according to the intended use.

Next, an example in which the index (5) is used will be explained. According to the instructing amount of frequency increase or decrease f_{conti} from a base station BSi having a certain relative velocity or less which results in judgment that the reception quality is sufficient to be reliable, the mobile station MS increases or decreases its transmission and reception frequencies. When two or more base stations having the above-mentioned certain relative velocity or less exist, the instructing amount of frequency increase or decrease f_{conti} from a base station BSi with the lowest relative velocity can be used by assuming that the instructing amount of frequency increase or decrease f_{conti} has a high degree of reliability. As an alternative, in order to improve the quality of communications with a base station BSi having a relatively-high relative velocity compared with those of the other base stations, the instructing amount of frequency increase or decrease f_{conti} from the base station BSi can be used. How to select the instructing amount of frequency increase or decrease f_{conti} which is used for the frequency increase or decrease is arbitrarily determined according to the intended use.

Next, an example in which the index (6) is used will be explained. According to the instructing amount of frequency increase or decrease f_{conti} from a base station BSi having a certain Doppler shift amount or less which results in judgment that the reception quality is sufficient to be reliable, the mobile station MS increases or decreases its transmission and reception frequencies. When two or more base stations having the above-mentioned certain Doppler shift amount or less exist, the instructing amount of frequency increase or decrease f_{conti} from a base station BSi with the smallest Doppler shift amount can be used by assuming that the instructing amount of frequency increase or decrease f_{conti} has a high degree of reliability. As an alternative, in order to improve the quality of communications with a base station BSi having a relatively-large Doppler shift amount compared with those of the other base stations, the instructing amount of frequency increase or decrease f_{conti} from the base station BSi can be used. How to select the instructing amount of frequency increase or decrease f_{conti} which is used for the frequency increase or decrease is arbitrarily determined according to the intended use.

Next, an example in which the index (7) is used will be explained. According to the instructing amount of frequency increase or decrease f_{conti} from a base station BSi having a certain communication duration or more which results in judgment that the reception quality is sufficient to be reliable, the mobile station MS increases or decreases its transmission and reception frequencies. When two or more base stations having the above-mentioned certain communication duration or more exist, the instructing amount of frequency increase or decrease f_{conti} from a base station BSi with the longest communication duration can be used by assuming that the instructing amount of frequency increase or decrease f_{conti} has a high degree of reliability. As an alternative, in order to improve the quality of communications with a base station BSi having a relatively-short communication duration compared with those of the other base stations, the instructing amount of frequency increase or decrease f_{conti} from the base station BSi can be used. How to select the instructing amount of frequency increase or decrease f_{conti} which is used for the frequency increase or decrease is arbitrarily determined according to the intended use.

Next, an example in which the index (8) is used will be explained. According to the instructing amount of frequency increase or decrease f_{conti} from a base station BSi having a certain frequency deviation or less which results in judgment that the reception quality is sufficient to be reliable, the mobile station MS increases or decreases its transmission and reception frequencies. When two or more base stations having the above-mentioned certain frequency deviation or less exist, the instructing amount of frequency increase or decrease f_{conti} from a base station BSi with the smallest frequency deviation can be used by assuming that the instructing amount of frequency increase or decrease f_{conti} has a high degree of reliability. As an alternative, in order to improve the quality of communications with a base station BSi having a relatively-large frequency deviation compared with those of the other base stations, the instructing amount of frequency increase or decrease f_{conti} from the base station BSi can be used. How to select the instructing amount of frequency increase or decrease f_{conti} which is used for the frequency increase or decrease is arbitrarily determined according to the intended use.

Next, an example in which the index (9) is used will be explained. According to the instructing amount of frequency increase or decrease f_{conti} from a base station BSi having a certain accuracy degree of trackability to the downlink transmission power control or more which results in judgment that the reception quality is sufficient to be reliable, the mobile station MS increases or decreases its transmission and reception frequencies. When two or more base stations having the above-mentioned certain accuracy degree of trackability to the downlink transmission power control or more exist, the instructing amount of frequency increase or decrease f_{conti} from a base station BSi with the highest degree of trackability to the downlink transmission power control can be used by assuming that the instructing amount of frequency increase or decrease f_{conti} has a high degree of reliability. As an alternative, in order to improve the quality of communications with a base station BSi having a relatively-low degree of trackability to the downlink transmission power control, compared with those of the other base stations, the instructing amount of frequency increase or decrease f_{conti} from the base station BSi can be used. How to select the instructing amount of frequency increase or decrease f_{conti} which is used for the frequency increase or decrease is arbitrarily determined according to the intended use.

Finally, an example in which the index (10) is used will be explained. According to the instructing amount of frequency increase or decrease f_{conti} from the base station BSi having a certain accuracy degree of trackability of the phase angle between the downlink common CH and the dedicated CH for the FBI command or more which results in judgment that the reception quality is sufficient to be reliable, the mobile station MS increases or decreases its transmission and reception frequencies. When two or more base stations having the above-mentioned certain accuracy degree of trackability of the phase angle between the downlink common CH and the dedicated CH for the FBI command or more exist, the instructing amount of frequency increase or decrease f_{conti} from a base station BSi with the highest degree of trackability to the downlink transmission power control can be used by assuming that the instructing amount of frequency increase or decrease f_{conti} has a high degree of reliability. As an alternative, in order to improve the quality of communications with a base station BSi having a relatively-low degree of trackability of the phase angle between the downlink common CH and the dedicated CH for the FBI command, compared with those of the other base stations, the instructing amount of frequency increase or decrease f_{conti} from the base station BSi can be used. How to select the instructing amount of frequency increase or decrease f_{conti} which is used for the frequency increase or decrease is arbitrarily determined according to the intended use.

An explanation will be returned to the processes carried out by the base station BSi and the mobile station MS again. The mobile station MS performs uplink transmission to the base station BSi at a frequency (f_{MSi}=f_{MSi}′+f_{conti}−f_{offset}) which is newly increased or decreased. The increase or decrease in the frequency follows the instructing amount of frequency increase or decrease f_{conti} which is selected, in step SMS5′, according to the importance of communications with each base station.

As an example, the uplink transmission frequency for the base station BS1 is given as follows:

f_{MS1}=f_{MS1}′+f_{cont1}−f_{offset}

or

f_{MS1}=f_{MS1}+f_{cont2}−f_{offset}

The uplink transmission frequency for the base station BS2 is given as follows:

f_{MS2}=f_{MS2}′+f_{cont1}−f_{offset}

or

f_{MS2}=f_{MS2}+f_{cont2}−f_{offset}

In this case, the mobile station MS transmits the frequency deviation Δf_{MSi} detected from the downlink signal received thereby to each base station BSi as well (step SMS6″).

When the base station BSi then receives an uplink signal, which is transmitted from the mobile station MS at the uplink transmission frequency (f_{MSi}=f_{MSi}′+f_{conti}−f_{offset}), at a reference frequency (f_{BSi}=f_{BSi}−f_{offset}), a frequency deviation Δf_{BSij} occurs in the uplink signal.

Therefore, in the base station BSi, the uplink reception frequency is observed as shown by the following equation (step SBS4′):

f_{BSi}′=f_{MSi}+f_{conti}−f_{offset}+Δf_{BSij}=(f_{BSi}+Δf_{MSi})+f_{conti}−f_{offset}+Δf_{BSij}

As an example, the uplink reception frequency of the base station BS1 is given as follows:

f_{BS1}′=f_{BS1}+Δf_{MS1}+f_{cont1}−f_{offset}+Δf_{BS11}

or

f_{BS1}′=f_{BS1}+Δf_{MS1}+f_{cont2}−f_{offset}+Δf_{BS21}

The uplink reception frequency of the base station BS2 is given as follows:

f_{BS2}′=f_{BS2}+Δf_{MS2}+f_{cont1}−f_{offset}+Δf_{BS12}

or

f_{BS2}′=f_{BS2}+Δf_{MS2}+f_{cont2}−f_{offset}+Δf_{BS22}

The base station BSi detects Δf_{BSij} from the uplink reception frequency measured in step SBS4 (step SBS5′).

Finally, the base station SB and the mobile station MS end their transmission-and-reception loops, and ends their respective processes (steps SBS6 and SMS7).

As mentioned above, in accordance with this Embodiment 3, even in a case in which the mobile station which is communicating with two or more base stations simultaneously receives an instruction for specifying a different frequency increase or decrease from each base station, the mobile station can maintain a good communicating state with a base station with which the mobile station is carrying out communications of greater importance by increasing or decreasing its frequencies according to the instruction from the base station of greater importance in communications. Furthermore, in a case in which it is judged that the quality of communications with the base station of greater importance is sufficiently good, the mobile station can maintain a good diversity communicating state with the two or more base stations by following a frequency increase or decrease instruction from a base station of relatively-lower importance.

### INDUSTRIAL APPLICABILITY

As mentioned above, the auto frequency control method in accordance with the present invention is used for a cellular phone system and so on, and is suitable for implementation of automatic frequency control which cannot be easily influenced by any Doppler shift.

1. An auto frequency control method comprising:
a first step of a base station detecting a frequency deviation of an uplink signal transmitted from a mobile station;
a second step of said base station transmitting an instructing amount of increase or decrease in a transmission frequency of said uplink signal to said mobile station on a basis of the frequency deviation of said uplink signal; and
a third step of said mobile station shifting the transmission frequency of said uplink signal according to said instructing amount of increase or decrease transmitted from said base station.

2. The auto frequency control method according to claim 1, characterized in that said method includes a fourth step of said mobile station transmitting a frequency deviation of a downlink signal from said base station to said base station, and, in said second step, said base station transmits said instructing amount of increase or decrease to said mobile station on a basis of the frequency deviation of said uplink signal and the frequency deviation of said downlink signal.

3. The auto frequency control method according to claim 1, characterized in that said method includes a fifth step of said mobile station detecting the frequency deviation of said downlink signal.

4. The auto frequency control method according to claim 2, characterized in that in said second step, a plurality of said base stations transmit their respective instructing amounts of increase or decrease to said mobile station, and, in said third step, said mobile station selects said instructing amount of increase or decrease on a basis of importance of communications between each of said base stations and said mobile station, and shifts the transmission frequency of said uplink signal according to the selected instructing amount of increase or decrease.

5. The auto frequency control method according to claim 4, characterized in that as an index used for judgment of the importance of the communications between each of said base stations and said mobile station, a signal-to-power ratio of said downlink signal of said mobile station for each of said base stations is used.

6. The auto frequency control method according to claim 4, characterized in that as an index used for judgment of the importance of the communications between each of said base stations and said mobile station, a receive error rate of said downlink signal of said mobile station for each of said base stations is used.

7. The auto frequency control method according to claim 4, characterized in that as an index used for judgment of the importance of the communications between each of said base stations and said mobile station, a distance between each of said base stations and said mobile station is used.

8. The auto frequency control method according to claim 4, characterized in that as an index used for judgment of the importance of the communications between each of said base stations and said mobile station, uplink transmission power of said mobile station for each of said base stations is used.

9. The auto frequency control method according to claim 4, characterized in that as an index used for judgment of the importance of the communications between each of said base stations and said mobile station, a relative velocity between each of said base stations and said mobile station is used.

10. The auto frequency control method according to claim 4, characterized in that as an index used for judgment of the importance of the communications between each of said base stations and said mobile station, a Doppler shift amount of said downlink signal of said mobile station for each of said base stations is used.

11. The auto frequency control method according to claim 4, characterized in that as an index used for judgment of the importance of the communications between each of said base stations and said mobile station, a communication duration between each of said base stations and said mobile station is used.

12. The auto frequency control method according to claim 4, characterized in that as an index used for judgment of the importance of the communications between each of said base stations and said mobile station, a frequency deviation of said downlink signal of said mobile station for each of said base stations is used.

13. The auto frequency control method according to claim 4, characterized in that as an index used for judgment of the importance of the communications between each of said base stations and said mobile station, trackability of reception quality of said downlink signal for a downlink transmission power control command which said mobile station transmits to each of said base stations is used.

14. The auto frequency control method according to claim 4, characterized in that as an index used for judgment of the importance of the communications between each of said base stations and said mobile station, trackability of reception power of said downlink signal for a downlink transmission power control command which said mobile station transmits to each of said base stations is used.

15. The auto frequency control method according to claim 4, characterized in that as an index used for judgment of the importance of the communications between each of said base stations and said mobile station, trackability of a phase angle between a downlink common channel and a dedicated channel, which is transmitted from each of said base stations, for a command, which said mobile station transmits to each of said base stations, for specifying the phase angle between said downlink common channel and said dedicated channel is used.
